(19) United States
(12) Patent Application Publication
(10) Pub. No.: US 2024/0271815 A1
(43) Pub. Date: Aug. 15, 2024

(54) Method and apparatus for process optimization via ambient condition forecasting

(71) Applicant: Elemental Machines, Inc., Cambridge, MA (US)

(72) Inventors: Casey Peters, Caldwell, NJ (US); Sridhar Iyengar, Salem, NH (US); Ian Harding, Wells Somerset (GB)

(73) Assignee: Elemental Machines, Inc., Cambridge, MA (US)

(21) Appl. No.: 18/568,935

(22) PCT Filed: Jun. 10, 2022
(86) PCT No.: PCT/US2022/033025

§ 371 Date: Dec. 11, 2023

Related U.S. Application Data
(60) Provisional application No. 63/216,140, filed on Jun. 29, 2021.

(51) Int. Cl. F24F 11/63; F24F 110/12; F24F 110/22; F24F 110/64; G05B 13/02

(52) U.S. Cl. CPC F24F 11/63; G05B 13/024; F24F 2110/12; F24F 2110/22; F24F 2110/64; G05B 2219/2614

(57) ABSTRACT

A method is provided for determining whether a future time period for performing a future process run is satisfactory. The process run employs process equipment disposed within an interior space. In a first step a relationship is obtained between an environmental condition within the interior space and an environmental condition exterior to the interior space. In a second step a future value representative of the environmental condition exterior to the interior space during the future time period is obtained. In a third step a predicted value representative of the environmental condition within the interior space during the future time period is determined by comparing the future value obtained in step (b) to the relationship obtained in step (a). Next the predicted value determined in step (c) is compared to a reference. It is then determined from the comparison whether the future time period for performing the future process run is satisfactory.

### CROSS-REFERENCE TO RELATED APPLICATIONS

This application claims priority to U.S. Prov. Application Ser. No. 63/216,140 filed on Jun. 29, 2021 and is related to U.S. Prov. Application Ser. No. 62/739,427 filed on Oct. 1, 2018; U.S. application Ser. Nos. 16/589,347 and 16/589,713 filed on Oct. 1, 2019 and Ser. No. 16/960,772 filed on Jul. 8, 2020; and PCT Application Serial Nos. PCT/US2019/53941 and PCT/US2019/53977 filed on Oct. 1, 2019; all of which are incorporated in their entireties herein by reference for all purposes.

### BACKGROUND OF INVENTION

Executing a process defined by a protocol or procedure is part of modern industry. For example, scientists execute experimental protocols, health care providers execute clinical protocols, factory workers execute manufacturing procedures. For a successful outcome, one must execute the steps of such protocols and processes in a reproducible manner. However, there are challenges to doing so. Since these processes are executed in the real physical world, there are myriad variables that can introduce errors and variations to lessen the reproducibility and repeatability. These reproducibility problems are well known in industry and as a result much effort is taken to control the independent variables. For example, HVAC systems are designed to control ambient temperature, air filters are designed to filter out particulates, environmental chambers offer control of temperature and humidity in small spaces, machines and instruments are regularly maintained and calibrated, etc.

Traditional approaches to mitigating the deleterious effects of environmental variations on processes have generally been to actively control the environment to maintain environmental variations within desired ranges. However, such methods are costly to implement across an entire facility or limited to smaller controlled spaces, isolated from the larger facility. It may generally not be economically feasible to turn an entire building into an environmental chamber. Accordingly, implementation of large-scale environmental control is limited to the most sensitive of applications.

Traditional methods have taken the approach of actively controlling the environment so that the process that is to be executed can remain relatively unchanged. However, and again, it is expensive, time and resource consuming, if not impossible to control environmental conditions in large spaces or throughout the entire facility etc. Accordingly, there is a need for a solution that can equivalently offer the same benefits as controlling ambient conditions but without the added cost and complexity associated with actively controlling the environment. A solution that does not attempt to actively control the environment but rather can be used to either mitigate or take advantage of the environmental variations and adjust a process accordingly is desired. The present invention provides such solutions.

### BRIEF SUMMARY OF INVENTION

The invention described herein presents solutions to the above-described problems whereby a process or protocol may be altered to accommodate a change in environmental condition(s). In a first embodiment, the present invention provides a method for determining whether a future time period for performing a future process run is satisfactory. The process run employs process equipment disposed within an interior space. The method includes steps (a) to (e), including: (a) obtaining a relationship between an environmental condition within the interior space and an environmental condition exterior to the interior space; (b) obtaining a future value representative of the environmental condition exterior to the interior space during the future time period; (c) determining a predicted value representative of the environmental condition within the interior space during the future time period by comparing the future value obtained in step (b) to the relationship obtained in step (a); (d) comparing the predicted value determined in step (c) to a reference; and (e) determining from the comparison in step (d) whether the future time period for performing the future process run is satisfactory.

In a further embodiment, the present invention provides a method for performing a process run. The steps include a first and second step of (I) providing process equipment disposed within an interior space and (II) using the process equipment disposed within the interior space during a given time period to perform steps of a process run. Prior to performing step (II), however, the method comprises the further step of: (III) determining whether the given time period for performing the process run is satisfactory by performing any of the methods described herein for determining whether a future time period (e.g. the given time period) for performing the run is acceptable.

In a further embodiment, an apparatus (such as a display, a computer, a software package, a module and/or a node) is provided for controlling/coordinating or providing instruction on process flows. The apparatus includes a printed list describing or containing and/or circuitry programmed with instructions for performing the steps outlined in any of them methods herein described.

### BRIEF DESCRIPTION OF THE DRAWINGS

FIGS. 1 to 3 show results and data reported in Example 1.

FIGS. 4 to 6 show results and data reported in Example 2.

FIG. 7 shows results and data reported in Example 3.

FIGS. 8 to 10 show results and data reported in Example 4.

FIG. 11 shows an example embodiment of sending an indication to a user.

### DETAILED DESCRIPTION

The present invention provides solutions to the above-described problems in the art and in particular provides the ability to alter a process or protocol to accommodate changes in environmental condition(s). The present inventors have herein found that the present methods, processes and apparatus provide for saving resources and in turn providing for process and facilities efficiencies that have not been provided before and cannot be provided by simply altering ambient conditions within or external to facilities.

The methods and apparatuses described herein present solutions whereby a process or protocol may be altered to accommodate a changes in an environmental condition. In some embodiments, a method is provided for obtaining or determining, and optionally providing an alert containing and/or a data file comprising and/or improved display message containing, an acceptable or optimal time for performing an experiment, step in a protocol, or a process run. In other embodiments, a method is provided for performing an experiment, step in a protocol, or a process run at a given time wherein it is first determined whether the given time is acceptable or optimal.

In other embodiments, the invention describes methods and apparatuses for determining environmental conditions within a volume of space that contains at least a portion of a process to be executed (the “interior space”). The volume of space may be bounded, enclosed, partially bounded, partially enclosed inside of doors. In some embodiments, the interior space is inside a building. In other embodiments, the interior space is within a portion of a building. In another embodiment, the space is within an instrument or machine that is used in at least one part of a process. In other embodiments, the space is partially contained within an instrument or machine that is used in at least one part of a process. Non-limiting examples of such interior spaces include: inside a room; inside a laboratory; inside a factory; inside a vivarium; inside a greenhouse; the space surrounding a vicinity of a workbench where at least a portion of a process is to be executed; and the space predominantly contained within a safety hood such as a chemical fume hood or a biosafety hood among many other variations thereof.

The interior space may also include any surface that is used in a process. For example, the surface of a plate is considered a part of the interior space if the surface of the plate is involved in at least a portion of the process that is being executed.

In preferred embodiments, the methods and systems preferably comprise and/or make use of programmed circuitry including computer/program/processor/module/node/infrastructure programmed with logic/instructions and having circuitry comprised of hardware, software, memory, processors, data storage, computers, etc. which cause/create/effect operability of said systems and methods. In further preferred embodiments, resulting determinations are stored in memory as data and/or a data file and can be provided to a user as a message, alert, warning, and/or suggestion via a computer display or speaker etc.

Unless the context is specifically limiting the terms instrument, equipment, process equipment, analytical instrument, measurement instrument, laboratory instrument, process instrument, manufacturing instrument, analytical equipment, measurement equipment, laboratory equipment, manufacturing equipment, testing instrument/equipment, medical instrument/equipment, and facility management instrument/equipment, etc. are used interchangeably herein. These instruments and equipment are well known in the art and are not particularly limited herein.

The optimal environmental conditions for the process run to be executed on process equipment within the interior space may be determined empirically, obtained from equipment manufacturer specifications, or determined experimentally (for example as outlined in the US provisional application described above). The method preferably includes steps of obtaining, measuring, and/or determining ambient conditions related to the process over a period of time in the order of seconds, minutes, hours, days, weeks, months or years. The variables include those that may be affected by external environmental conditions, such as the environmental conditions not comprising the interior space.

The variables can include multiple different variables that may affect the quality of performing the process and/or the outcome/result achieved by the process when executed in the interior space. Non-limiting examples of variables can include: temperature, humidity (relative OR absolute), light intensity, vibration, air pressure, VOC concentration (volatile organic compounds), air quality (for example, particulate level, CO2 level, O2 level, air pollution level, etc.).

These environmental variables can be measured/determined/obtained using associated environmental sensors (or sensor packages) placed exterior and/or interior spaces and/or on or near equipment used in the process (e.g. laboratory and/or manufacturing equipment).

As these ambient conditions are collected, they are modeled against external environmental variables, that is variables that are outside the interior space. Non-limiting examples of external environmental variables include: temperature, humidity (relative OR absolute), dew point, precipitation, cloud cover, visibility, and/or air quality (PM2.5 & PM10). In preferred embodiments, these variables can also be associated with result metrics of the process to determine whether the environmental variables correlate with results of the process and be used to inform a user of the likelihood of success of the process and/or provide suggestion of a future time to complete the process or step thereof and/or provide a suggestion of why the result of the process was obtained.

### ADDITIONAL PREFERRED METHODS OF THE INVENTION

In another preferred embodiment, a method is provided for determining whether a future time period for performing a future process run is satisfactory. The process run employs process equipment disposed within an interior space and the method includes at least steps (a) to (e). The steps and methods are preferably performed such that the likelihood of success of the process run is improved.

In step (a) a relationship is obtained between an environmental condition within the interior space and an environmental condition exterior to the interior space. Here, the relationship can be empirically determined by observing the respective environmental conditions over time to empirically develop a modeled relationship between environmental conditions within and exterior to the interior space. In the alternative, or in addition to empirical analysis, the relationship can also be determined from searching a database for known values of the correlation or otherwise values of the sought relationship which have been previously determined by others or which could be said to be derived from a natural law etc. For non-limiting examples, it may be determined from a database (e.g. an internet website), academic literature, a research article, a textbook, etc. that when a particular external environmental condition is between a certain range or is a certain value then this corresponds to an internal environmental condition within an interior space of a corresponding value. For example, when external temperature is 90 degrees F. and/or the daylight value is more than 13 hours (e.g. summer time) and/or pollution levels fall within Y range etc. then environmental conditions (such as for example temperature/humidity) within the interior space are within X, Y′, Z ranges etc. (e.g. 68-72 degrees F. and/or between 10-50% relative humidity). The correlation or value can then be stored in computer memory and used in further steps of the process.

In another embodiment, the relationship obtained in step (a) can be obtained by performing the additional steps of: (i) obtaining a value representative of an environmental condition within the interior space at a given time, (ii) obtaining a value representative of an environmental condition exterior to the interior space at the given time, and (iii) determining the relationship by comparison of the environmental condition within the interior space obtained in step (i) and the environmental condition exterior to the interior space obtained in step (ii). Alternatively, the relationship obtained in step (a) is obtained from lookup tables comparing an environmental condition within the interior space and an environmental condition exterior to the interior space in specific geographical locations. The correlation or value can then be stored in computer memory and used in further steps of the process.

In step (b) a future value is obtained that is representative of the environmental condition exterior to the interior space during the future time period. In this step, a predicted, forecast, OR historically average value of the environmental condition can be obtained. This can be obtained for example via lookup table, searching databases or the internet. For example, if the future time period is at a certain time of day, week, month, or year, the value of the environmental condition can be obtained or otherwise determined. In another example, the future value may be obtained from weather forecast data. The correlation or value can then be stored in computer memory and used in further steps of the process.

From this future value determined in step (b) a predicted value representative of the environmental condition within the interior space during the future time period can be determined in a step (c) by comparing the future value obtained in step (b) to the relationship obtained in step (a). For example, when the future predicted value external to the interior space is X (or within X range), then it can be determined/deduce/determined or otherwise predicted that the environmental condition of concern within the interior space is Y (or within Y range). A margin of error for the predicted value (or range) of the interior space may also be determined based on the uncertainty of the future value obtained in step (b). The correlation or value can then be stored in computer memory and used in further steps of the process.

In a step (d) the predicted value of the environmental condition of concern within the interior space determined in step (c) is compared to a reference/lookup table/etc. This reference/lookup table/etc. can be a variable which directly affects the quality of the process run and/or quality control of the facility or operating conditions of the raw material, process equipment or finished product for example. The correlation or value can then be stored in computer memory and used in further steps of the process.

In a step (e) it can be determined from the comparison in step (d) whether the future time period for performing the future process run is satisfactory. For example, if the predicted value of the environmental condition of concern within the interior space is outside OR within a range, then it can be determined the environmental conditions within the interior space are such that the process run can be run satisfactorily with a known chance of achieving acceptable and/or reproducible results and accordingly that the future time for performing the suggested run are or may otherwise be acceptable. If on the other hand the comparison reveals the environmental conditions are outside of operating parameters, then it can be determined that the future time for performing the suggested run is not or may not acceptable. Here, for non-limiting example it can be determined that the process run is using a chemical, product, or reaction which has a particular sensitivity to ambient conditions such as temperature or humidity, the comparison in step (d) and analysis in step (f) allows for determination of the relative likelihood or chance of successful completion of the process run. For example, if the future/predicted value of humidity within the interior space is elevated or above a threshold value, the chances of using a particular chemical or process step may be diminished thereby reducing the likelihood of success of the process run and thereby increasing wasted time and resources if the process run were performed at the planned future time.

Depending on the determination provided in step (e) of whether the future time is acceptable or not, then an indication to a user can be provided in a further step. Here, in a further step (f) an instruction, message, warning, alert, computer display etc. can be provided to a user to: abandon the future process run, perform the future process run during the future time period, modify a parameter of the future process run, modify the environmental condition within the interior space during the future time period, or modify the future time period of the future process run. Any of these actions optionally coupled with providing supplemental information to the user as to the nature of the predicted/forecast environmental conditions within and/or exterior internal space at the planned future time AND/OR at the modified or suggested future time.

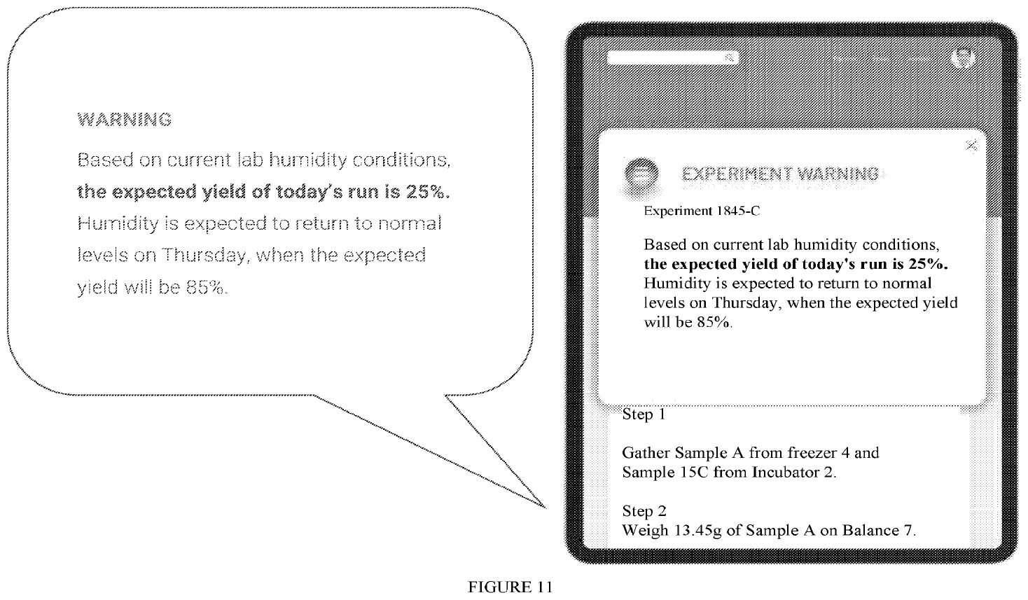

Alternatively and in further preferred embodiments, if it is determined that the future time period for performing a future process run is not satisfactory, the method further comprises step: (g) determining a satisfactory alternative future time period for performing the future process run by: (I) obtaining future values representative of the environmental condition exterior to the interior space at a multitude of alternative future times; (II) determining a multitude of predicted values representative of the environmental condition within the interior space at the multitude of alternative future times by comparing the multitude of forecast values from step (I) to the correlation obtained in step (a); (III) comparing the multitude of predicted values determined in step (II) to a reference; and (IV) determining a satisfactory alternative future time period for performing the future process run from the comparison in step (III); and (V) providing an instruction, warning, alert, message, computer display, recommendation etc. to: perform the future process run at the satisfactory alternative future time period. The process run can then/is then preferably completed at the different suggested future time. Optionally, the instruction or recommendation to the user may include predicted conditions at the satisfactory alternative future time period. One example of an instruction or recommendation to the user is shown in FIG. 11 where a message is sent to a user's smart phone.

Alternatively and in further preferred embodiments, if it is determined that the future time period for performing a future process run is not satisfactory, the method further comprises step: (g) determining a satisfactory alternative interior space for performing the future process run: (I) obtaining forecast values representative of the environmental condition exterior to a multitude of interior spaces at the future time period: (II) determining a multitude of predicted values representative of the environmental condition within the multitude of interior spaces at the future time period by comparing the forecast values from step (I) to the correlation obtained in step (a); (III) comparing the multitude of predicted values determined in step (II) to a reference; and (IV) determining a satisfactory alternative interior space for performing the future process run from the comparison in step (III); and (V) providing an instruction, warning, alert, computer displayed, recommendation to: perform the future process run at the alternative interior space at the future time period. The process run can then/is then preferably completed at the different suggested future time.

In yet another embodiment, the present invention provides a method for performing a process. The method includes the steps of: (I) providing process equipment disposed within an interior space, (II) using the process equipment disposed within the interior space during a given time period to perform steps of a process run, wherein prior to performing step (II), the method comprises the further step of: (III) determining whether the given time period for performing the process run is satisfactory by performing another the methods of determining acceptability of a future time of a process run described herein.

In a further embodiment, the present invention provides a method of providing a data file and/or computer displayed message, warning, alert, suggestion, direction etc. regarding a preferred time to perform a process. The method includes the steps of creating a data file, storing the data file in computer memory, and rendering contents of the data file on a computer display employing any or all of the steps of the associated methods described above.

### Additional Apparatuses of the Present Invention

In further preferred embodiments, the present invention provides data files, audible or visual displays, apparatuses for controlling/coordinating process flows, comprising circuitry programmed with instructions for performing the steps outlined in any of methods described herein, including providing audible or visual messaging (such as a computer display/speaker) to a user.

The present invention further provides a printed set of instructions comprising instructions AND/OR a computer, software package, a module and/or a node programed with logic and/or instructions for performing any and/or all steps of performable by a computer processor comprising instructions to perform any and all of the steps of any method described herein.

In a further preferred embodiment, the present invention provides a process management system (PMS). The PMS comprises: an application server running a PMS server application; a process instrument or equipment disposed within an interior space and in direct or indirect communication with the application server. The PMS server application comprises: logic and/or instructions for a processor or server to perform any and/or all steps of the methods as described herein.

The PMS can further comprise any or all of the following systems and/or modules:

Environmental sensors for determining internal/external environmental conditions;
a data obtaining system in direct or indirect communication with the application server; for example wherein the data obtaining system comprises logic and/or instructions for a processor or server to obtain or identify a relationship between an environmental condition within the interior space and an environmental condition exterior to the interior space, optionally obtained from the environmental sensors; and to obtain a future value representative of the environmental condition exterior to the interior space during the future time period;
a determination module in direct or indirect communication with the application server; for example wherein the determination module comprises logic and/or instructions for a processor or server to determine a predicted value representative of the environmental condition within the interior space during the future time period by comparing the future value to the relationship obtained by the data obtaining system;
a comparison module in direct or indirect communication with the application server; for example wherein the comparison module comprises logic and/or instructions for a processor or server to compare the predicted value determined by the determination module to a reference in order to determine whether a future time period for performing the future process run is satisfactory.

### EXAMPLES

The following examples are provided simply to illustrate concepts of the present invention and are not to be considered limiting thereof.

### Example 1

FIG. 1 (101) shows the error associated with a given process for a range of indoor relative humidity. At low and high humidity levels there is large error in the process. There is a ‘sweet spot’ identified by 102 which comprises a range of humidity levels that result in low error. This is the optimal range for the process.

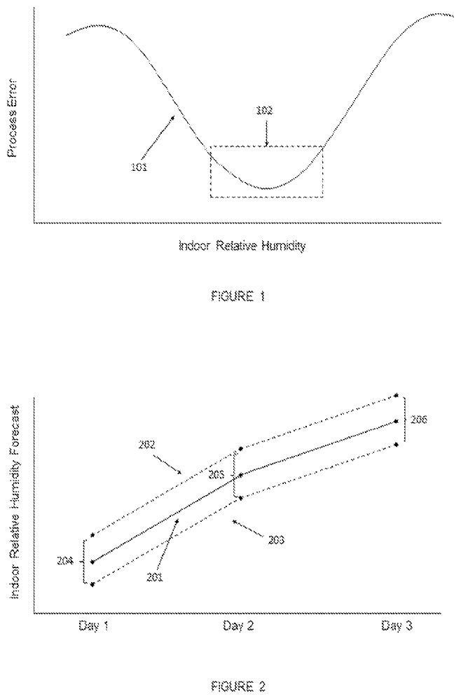

FIG. 2 shows the forecast indoor relative humidity for the next three days. Line 201 represents the expected humidity with lines 202 & 203 showing the upper and lower bounds for the ambient forecast model described above. 204-206 show the expected range of humidity values for Day 1, Day 2, and Day 3, respectively.

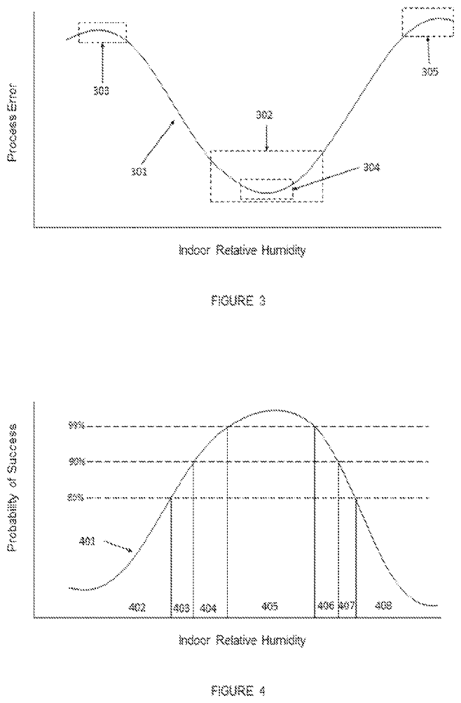

FIG. 3 again shows the error associated with the process to be performed for a range of indoor relative humidity. 301 shows the error at each humidity level. 302 identifies the ‘sweet spot’ for the process. 303 shows the range of predicted humidity and thereby predicted error for the process on Day 1. 304 shows the range of predicted humidity and thereby predicted error for the process on Day 2. 305 shows the range of predicted humidity and thereby predicted error for the process on Day 3. From this, it is clear that the Day 2 forecast falls within the ‘sweet spot’ and the process step should be scheduled for Day 2.

### Example 2

FIG. 4 (401) shows the probability of success associated with a given process for a range of indoor relative humidity. This has been determined from historical process data as outlined in U.S. patent application Ser. No. 16/589,713 filed on Oct. 1, 2019. At low and high humidity levels there is a decreased probability of a successful outcome. At the optimal humidity range (405) there is >99% chance of a successful outcome. In the humidity ranges 404 & 406 there is a 90-99% chance of a successful outcome. In the humidity ranges 403 & 407 there is an 80-90% chance of a successful outcome. In the humidity ranges 402 & 408 there is <80% chance of a successful outcome.

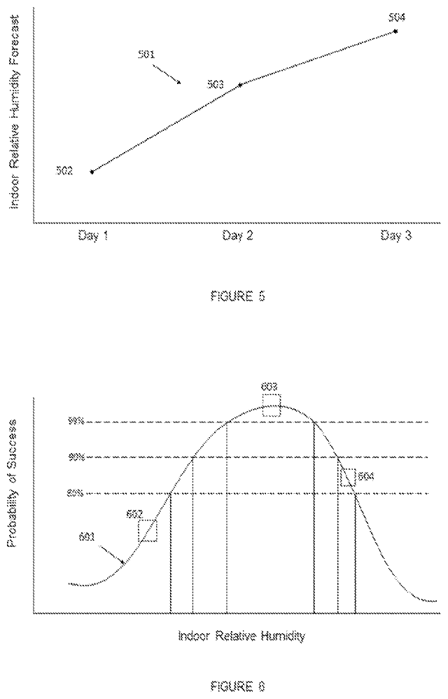

FIG. 5 shows the forecast indoor relative humidity for the next three days. Line 501 represents the expected humidity based on the ambient forecast model described above. 502-504 show the expected humidity values for Day 1, Day 2, and Day 3, respectively.

FIG. 4 again shows the probability of success associated with the process to be performed for a range of indoor relative humidity. 601 shows the probability of success at each humidity level. 602 shows the predicted humidity and thereby predicted probability of success for the process on Day 1 is <80%. 603 shows the predicted humidity and thereby predicted probability of success for the process on Day 2 is >99%. 604 shows the predicted humidity and thereby predicted probability of success for the process on Day 3 is 80-99%. From this, it is clear that in order to achieve the highest probability of success the process should be performed on Day 2. If that is not possible, Day 3 is the next best option, followed by Day 1.

### Example 3

In this example, Company A has determined from historical process data as outlined in U.S. patent application Ser. No. 16/589,713 filed on Oct. 1, 2019 that one of their multiple day processes is only successful when the humidity on Day 2 is less than that on Day 1. An increase in humidity has detrimental effects on compound quality after the completion of the Day 1 steps.

FIG. 7 shows the forecast indoor relative humidity for the next three days. Line 701 represents the expected humidity based on the ambient forecast model described above. 702-708 show the expected humidity values for Day 1-Day 7, respectively.

From the forecast it can be seen that Day 2-3 (709), Day 4-5 (710), and Day 6-7 (711) all have Day 2 indoor humidity less than Day 1 humidity. Therefore, Company A should schedule the process to be started on Day 2, Day 4, or Day 6 to ensure success.

### Example 4

In a further example, the present invention provides the ability to determine a correlation between external and internal environmental conditions in the determination of whether a proposed future time period for conducting a process run is satisfactory. In this example correlations can be extracted between external conditions and internal conditions and accordingly the likelihood of obtaining acceptable and/or preferred chances of achieving a successful process run can be determined. Said embodiments can be used to provide higher visibility in scheduling of process run and/or process equipment within the laboratory and/or manufacturing facility.

Here, a sufficient number of data points from existing process conditions can be collected and a model of conditions of the Interior Space against the corresponding outdoor environmental conditions (e.g. indoor relative humidity can be modeled against external (outdoor) temperature and relative humidity) can be provided using inter alia ordinary least squares regression, polynomial least squares regression, a neural network or some other statistical method known in the art. A sufficient number of data points can be determined in a number of ways including but not limited to: when a wide enough range of values are collected e.g. 20-60% Indoor RH; using power analysis to determine the proper sample size; when the model meets accuracy acceptance criteria.

Upon fitting the model, the exemplary method includes steps for predicting future ambient conditions within the interior space using external weather forecasting. Weather forecast data can be retrieved from any publicly available API or other data source (e.g. https://www.visualcrossing.com/weather-api etc.). The model is applied to the forecasted weather data to determine the forecasted indoor ambient conditions in the interior space. The indoor ambient forecast is then compared to the known optimal ambient conditions to determine the best day and/or time window to execute the process.

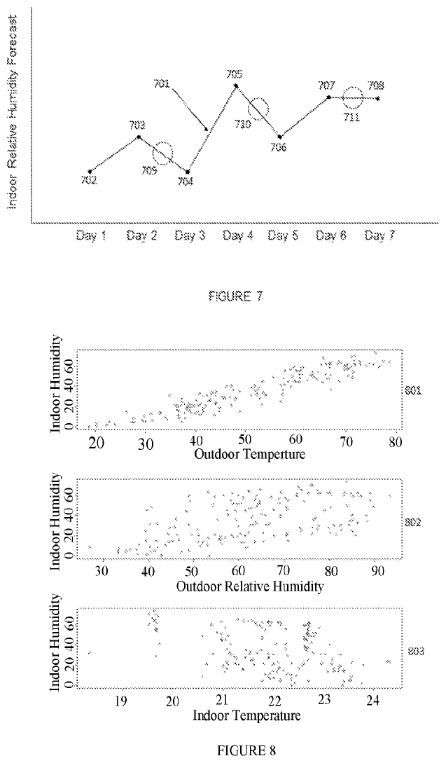

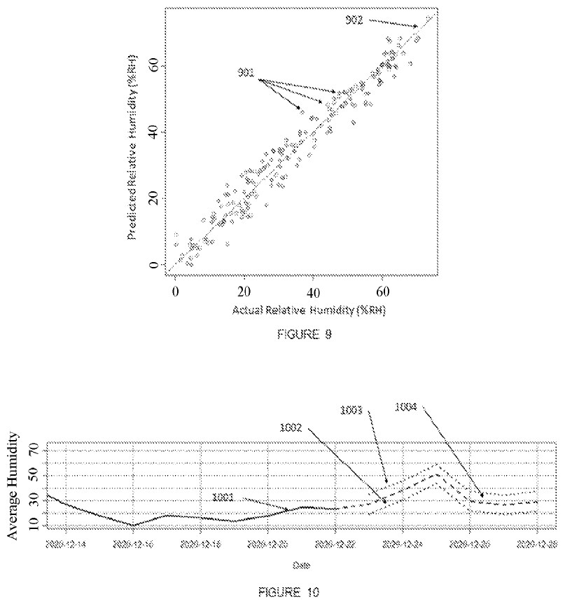

In the present example, daily humidity is forecast from daily indoor temperature, outdoor temperature, and outdoor humidity. FIG. 8 shows the historical data collected over the course of 12 months. 801 shows the indoor humidity vs outdoor temperature. 802 shows indoor humidity vs outdoor relative humidity. 803 shows indoor humidity vs indoor temperature. From the graphs in FIG. 8, it is clear that there is strong correlation between indoor humidity and outdoor temperature. There is also a correlation between outdoor temperature and indoor humidity, although it is weaker than the temperature correlation. This may seem counterintuitive to those unfamiliar with relative humidity, but this is in fact expected. The lower the temperature, the less moisture there can be in the air, for example 100% RH at 20 F contains less moisture than 50% RH at 60 F. When this air is warmed or cooled to indoor temperature, there is almost no change in the absolute humidity, therefore the indoor humidity is a function of the temperature difference as well as the relative humidity itself. Put another way, in the winter the indoor air is dry and during the summer the indoor air is humid.

Based on the plot indoor humidity vs outdoor temperature (801), there appears to be a classic S-curve, suggesting there is a cubic relationship between these two variables. To account for this, a polynomial linear regression will be fit to capture this cubic relationship in the form:

$$\\ RHindoors = B 0 + B 1 \times RHoutdoors + B 2 \times Temperatureoutdoors + B 3 \times ( Temperatureoutdoors ) 2 + B 4 \times ( Temperatureoutdoors ) 3 + B 5 \times Temperatureindoors$$

While it may seem like cheating to include indoor temperature as a regression term, since this will need to be forecasted as well, it is important to note that indoor temperature is relatively independent of the outside environment because most laboratories are temperature controlled at some level, which dramatically reduces the daily variability in temperature. Therefore, the indoor temperature can be forecast simply with a recent average for the purposes of this investigation. The term is most important for accounting for large seasonal changes in temperature due summer/winter differences or perhaps a set point change in the lab. These fluctuations should not increase the short-term uncertainty.

FIG. 9 shows the predicted humidity from the model plotted against the actual humidity. Each point (901) represents one day. 902 represents perfect fit.

FIG. 10 shows the forecast daily humidity for the next five days. 1001 shows the actual daily humidity up to the day of forecast. 1004 shows the expected forecast for the next five days. 1002 & 1003 shows the lower and upper 80% confidence interval, respectively, for the forecast.

Accordingly, via the example and disclosure above, environmental conditions within an interior space can be determined and a model created to allow future determination of interior environmental conditions. These predictive models are extremely powerful and provide for predicting future success of process runs and providing information to operators regarding whether the future contemplated time period for performing the process run will be successful. If not, different times can be suggested OR instruction can be provided to abandon the process run. In any event, the methods, process, apparatuses described herein provide for improvement in efficiencies and reduce waste. Such benefits are always sought in industry and provided herein.

Any external reference mentioned herein, including for example websites, articles, reference books, textbooks, granted patents, and patent applications are incorporated in their entireties herein by reference for all purposes.

Reference throughout the specification to “one embodiment,” “another embodiment,” “an embodiment,” “some embodiments,” and so forth, means that a particular element (e.g., feature, structure, property, and/or characteristic) described in connection with the embodiment is included in at least one embodiment described herein, and may or may not be present in other embodiments. In addition, it is to be understood that the described element(s) may be combined in any suitable manner in the various embodiments.

Numerical values in the specification and claims of this application reflect average values for a composition. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

1. A method for determining whether a future time period for performing a future process run is satisfactory, wherein the process run employs process equipment disposed within an interior space, the method comprises the steps of:
(a) obtaining a relationship between an environmental condition within the interior space and an environmental condition exterior to the interior space;
(b) obtaining a future value representative of the environmental condition exterior to the interior space during the future time period;
(c) determining a predicted value representative of the environmental condition within the interior space during the future time period by comparing the future value obtained in step (b) to the relationship obtained in step (a);
(d) comparing the predicted value determined in step (c) to a reference; and
(e) determining from the comparison in step (d) whether the future time period for performing the future process run is satisfactory.

2. The method of claim 1, wherein the method further comprises the step of: (f) providing a user with an instruction or recommendation to: abandon the future process run (optionally coupled with an explanation of rationale such as providing expected conditions within or exterior to the interior space and/or why this is an issue), perform the future process run during the future time period (optionally coupled rationale such as providing expected/predicted/forecast environmental conditions within and/or exterior to the interior space at the future time and why this is an issue etc.), modify a parameter of the future process run (optionally combined with said rationale), modify the environmental condition within the interior space during the future time period (optionally combined with said rationale), or modify the future time period of the future process run (optionally coupled said rationale and/or with providing expected/predicted/forecast environmental conditions within and/or exterior to the interior space at the modified future time and/or why this is a better time etc.).

3. The method claim 1, wherein the environmental condition within the interior space is selected from the group consisting of: temperature and humidity.

4. The method of claim 1, wherein the environmental condition exterior to the interior space is selected from the group consisting of: temperature, humidity, air pollution, air pressure, and light levels (e.g. sunrise/sunset times).

5. The method of claim 1, wherein the environmental condition within the interior space is humidity, and the environmental condition exterior to the interior space is temperature.

6. The method of claim 5, wherein the humidity is either relative or absolute humidity.

7. The method of claim 1, wherein the process equipment is selected from the group consisting of: laboratory equipment, manufacturing equipment, testing equipment, measuring equipment, metrology equipment, medical equipment, and facility management equipment.

8. The method of claim 1, wherein:
the interior space is enclosed by a building;
the environmental condition within the interior space is an ambient condition about the process equipment;
the exterior of the interior space is outside of the building;
the environmental condition exterior to the interior space is an ambient weather condition outside of and about the building; and
the forecast value representative of the environmental condition exterior to the interior space at the future time obtained in step (b) is obtained from a predicted weather forecast at the general geographic location of the building.

9. The method of claim 1, wherein the relationship obtained in step (a) is obtained by performing the additional steps of:
(i) obtaining a value representative of an environmental condition within the interior space at a given time,
(ii) obtaining a value representative of an environmental condition exterior to the interior space at the given time, and
(iii) determining the relationship by comparison of the environmental condition within the interior space obtained in step (i) and the environmental condition exterior to the interior space obtained in step (ii).

10. The method of claim 1, wherein the relationship obtained in step (a) is obtained from lookup tables comparing an environmental condition within the interior space and an environmental condition exterior to the interior space in specific geographical locations.

11. The method of claim 1, wherein if it is determined that the future time period for performing a future process run is not satisfactory, the method further comprises step: (g) determining a satisfactory alternative future time period for performing the future process run by:
(I) obtaining future values representative of the environmental condition exterior to the interior space at a multitude of alternative future times;
(II) determining a multitude of predicted values representative of the environmental condition within the interior space at the multitude of alternative future times by comparing the multitude of forecast values from step (I) to the correlation obtained in step (a);
(III) comparing the multitude of predicted values determined in step (II) to a reference; and
(IV) determining a satisfactory alternative future time period for performing the future process run from the comparison in step (III); and
(V) providing an instruction to: perform the future process run at the satisfactory alternative future time period.

12. The method of claim 1, wherein if it is determined that the future time period for performing a future process run is not satisfactory, the method further comprises step: (g) determining a satisfactory alternative interior space for performing the future process run:
(I) obtaining forecast values representative of the environmental condition exterior to a multitude of interior spaces at the future time period;
(II) determining a multitude of predicted values representative of the environmental condition within the multitude of interior spaces at the future time period by comparing the forecast values from step (I) to the correlation obtained in step (a);
(III) comparing the multitude of predicted values determined in step (II) to a reference; and
(IV) determining a satisfactory alternative interior space for performing the future process run from the comparison in step (III); and
(V) providing an instruction to: perform the future process run at the alternative interior space at the future time period.

13. The method of claim 1, wherein the steps are performed such that the likelihood of success of the process run is improved.

14. The method of claim 1, wherein upon completion of the steps the process run is initiated employing the process equipment disposed within an interior space at the future time or at a different suggested future time.

15. An apparatus for controlling/coordinating process flows, comprising circuitry programmed with instructions for performing the steps outlined in claim 1.

16. A computer, software package, a module and/or a node programed with logic and/or instructions for performing any and/or all steps of performable by a computer processor comprising instructions to perform the method of claim 1.

17. A printed set of instructions comprising instructions for performing the method of claim 1.

18. A successful process trajectory data file comprising a plurality of value sets of variables that affect the outcome of a process compiled from various individual runs of a given process.

19. A method for performing a process:
(I) providing process equipment disposed within an interior space,
(II) using the process equipment disposed within the interior space during a given time period to perform steps of a process run,
wherein prior to performing step (II), the method comprises the further step of:
(III) determining whether the given time period for performing the process run is satisfactory by performing the method of claim 1 for determining whether a future time period (e.g. the given time period) is acceptable.

20. A process management system (PMS) comprising:
an application server running a PMS server application;
a process instrument or equipment disposed within an interior space and in direct or indirect communication with the application server;
wherein the PMS server application comprises:
logic and/or instructions for a processor or server to perform any and/or all steps of the method of claim 1.

21. The PMS of claim 20, wherein the PMS comprises any or all of the following systems and/or modules:
a data obtaining system in direct or indirect communication with the application server; for example wherein the data obtaining system comprises logic and/or instructions for a processor or server to obtain or identify a relationship between an environmental condition within the interior space and an environmental condition exterior to the interior space; and to obtain a future value representative of the environmental condition exterior to the interior space during the future time period;
a determination module in direct or indirect communication with the application server; for example wherein the determination module comprises logic and/or instructions for a processor or server to determine a predicted value representative of the environmental condition within the interior space during the future time period by comparing the future value to the relationship obtained by the data obtaining system;
a comparison module in direct or indirect communication with the application server; for example wherein the comparison module comprises logic and/or instructions for a processor or server to compare the predicted value determined by the determination module to a reference in order to determine whether a future time period for performing the future process run is satisfactory.
